(19) United States
(12) Patent Application Publication
(10) Pub. No.: US 2018/0024813 A1
(43) Pub. Date: Jan. 25, 2018

(54) PSEUDO-RANDOM NUMBER GENERATION DEVICE AND COMPUTER READABLE MEDIUM

(71) Applicant: MITSUBISHI ELECTRIC CORPORATION, Tokyo (JP)

(72) Inventors: Yusuke NAITO, Tokyo (JP); Toru SORIMACHI, Tokyo (JP); Tomomi KASUYA, Tokyo (JP)

(73) Assignee: MITSUBISHI ELECTRIC CORPORATION, Tokyo (JP)

(21) Appl. No.: 15/549,047

(22) PCT Filed: Feb. 19, 2015
(86) PCT No.: PCT/JP2015/054608

§ 371 Date: Aug. 4, 2017

(51) Int. Cl. G06F 7/58; H04L 9/06

(52) U.S. Cl. CPC G06F 7/586; H04L 9/0625; H04L 9/0631

(57) ABSTRACT

A pseudo-random number generation device calculates a value st[i] of b[i] bits by using a function F[i] taking a value st[i−1] as input for each integer value i with i=1, . . . , n in ascending order. The pseudo-random number generation device calculates a value x[i] of r[i] bits by using a function g[i] taking as input at least a part of bits of a value st[j] and at least a part of bits of the value st[i] for at least a part of an integer value i with i=1, . . . , n, where a value j is an integer value smaller than the integer value i. The pseudo-random number generation device combines the values x[i] calculated by using the function g[i] to obtain a pseudo random number.

### TECHNICAL FIELD

The present invention relates to techniques for generating pseudo random numbers.

### BACKGROUND ART

A true random number is a value all the bits of which are randomly selected.

The Vernam cipher is an unbreakable cipher if true random numbers are used. In the Vernam cipher, an exclusive-OR of a plaintext m and a true random number r with the same bit length as the plaintext m is used as a ciphertext. In a case of performing a cryptographic communication between two parties using the Vernam cipher, it is necessary to share a true random number with a same length as a plaintext. As the plaintext desired to be sent becomes longer, the shared true random number becomes longer.

However, it is difficult to safely deliver a long true random number. Therefore, a pseudo random number is used instead of a true random number.

In a case of using a pseudo random number, a secret key with a fixed length of k bits is shared beforehand between two parties that perform a cryptographic communication, and by taking as input the secret key and a value IV different for each pseudo random number generation, a pseudo random number is generated by using a pseudo-random number generator function.

A pseudo-random number generator function is composed of a non-linear function, having a fixed input length and output length, and a mode of use defining a construction of generating a pseudo random number with an arbitrary length by using the non-linear function.

A pseudo-random number generator function is a function for which (1) and (2) as follows can be established.

(1) When it is assumed that a non-linear function is an ideal non-linear function, computational complexity for distinguishing a value output by the pseudo-random number generator function from a true random number is enormous. When required computational complexity for distinguishing a value output by a pseudo-random number generator function from a true random number is 2ⁿ, the pseudo random number generator function is said to have indifferentiability of n bits.

(2) Computational complexity for finding a property that a non-linear function is different from an ideal non-linear function is enormous. This is to say that computational complexity for the differential attack and the linear attack to be successful against a non-linear function is enormous.

In Non-Patent Literature 1, modes of use using the Sponge construction are described. In the modes of use using the Sponge construction, it is assumed that an input value and an output value of a non-linear function are b bits, and a value extracted from the non-linear function is r bits. Further, a secret key shared between two parties that perform a cryptographic communication is k bits. In Non-Patent Literature 2, it is described that if a non-linear function is an ideal function, the modes of use using the Sponge construction has indifferentiability with a min{c, b/2, k} bit random number, given c=b−r.

### CITATION LIST

### Non-Patent Literature

Non-Patent Literature 1: Guido Bertoni, Joan Daemen, Michael Peeters and Gilles Van Assche. “Cryptographic sponge functions.”
Non-Patent Literature 2: Philipp Jovanovic, Atul Luykx, Bart Mennink. “Beyond 2̂{c/2} Security in Sponge-Based Authenticated Encryption Modes” ASIACRYPT (1) 2014. pp. 85-104.
Non-Patent Literature 3: Federal Information Processing Standards Publication 197. Specification for the ADVANCED ENCRYPTION STANDARD (AES)
Non-Patent Literature 4: Kazumaro Aoki, Tetsuya Ichikawa, Masayuki Kanda, Mitsuru Matsui, Shiho Moriai, Junko Nakajima, Toshio Tokita. “Specification of Camellia—a 128-bit Block Cipher.”

### SUMMARY OF INVENTION

### Technical Problem

When a value c gets smaller, a bit length r extracted from a non-linear function gets longer. If the bit length r gets longer, the number of times to calculate the non-linear function can be reduced, and computational complexity for calculating a pseudo random number can be reduced. However, in the existing modes of use using the Sponge construction, the security of indifferentiability depends on the value c, and it is difficult to make the value c small.

The present invention is aimed at making security of indifferentiability not to depend on the value c.

### Solution to Problem

A pseudo-random number generation device according to the present invention includes:

a first function F calculation unit to calculate a value st[0] by using a function F[0];

a second function F calculation unit to calculate a value st[i] by using a function F[i] taking a value st[i−1] as input, for each integer value i with i=1, . . . , n in ascending order, where a value n is an integer value equal to or larger than 1;

a function g calculation unit to calculate a value x[i] by using a function g[i], taking as input at least a part of bits of a value st[j] and at least a part of bits of the value st[i], for one or more integer values i with i=1, . . . , n, where a value j is an integer value smaller than the one or more integer values i; and

a random number value calculation unit to calculate a pseudo random number from the value x[i] calculated by the function g calculation unit.

### Advantageous Effects of Invention

According to the present invention, a value st[i] calculated by using a function F[i] is not used directly, but is used after being converted using a value st[j] calculated by using a function F[j]. Thus, it becomes difficult to estimate the value st[i] calculated by using the function F[i], and it becomes possible to make security of indifferantiability not to depend on the value c.

### BRIEF DESCRIPTION OF DRAWINGS

FIG. 1 is a configuration diagram of a pseudo-random number generator function using the Sponge construction;

FIG. 2 is a configuration diagram of a pseudo-random number generator function according to a first embodiment;

FIG. 3 is a configuration diagram of a function g according to the first embodiment;

FIG. 4 is a configuration diagram of a pseudo-random number generation device 10 according to the first embodiment;

FIG. 5 is a flowchart illustrating processing of the pseudo-random number generation device 10 according to the first embodiment;

FIG. 6 is a configuration diagram of a non-linear function F according to a second embodiment;

FIG. 7 is a configuration diagram of a non-linear function F according to the second embodiment;

FIG. 8 is a diagram illustrating a hardware configuration of the pseudo-random number generation device 10 according to the first and second embodiments.

### DESCRIPTION OF EMBODIMENTS

### First Embodiment

### Explanation of Configuration

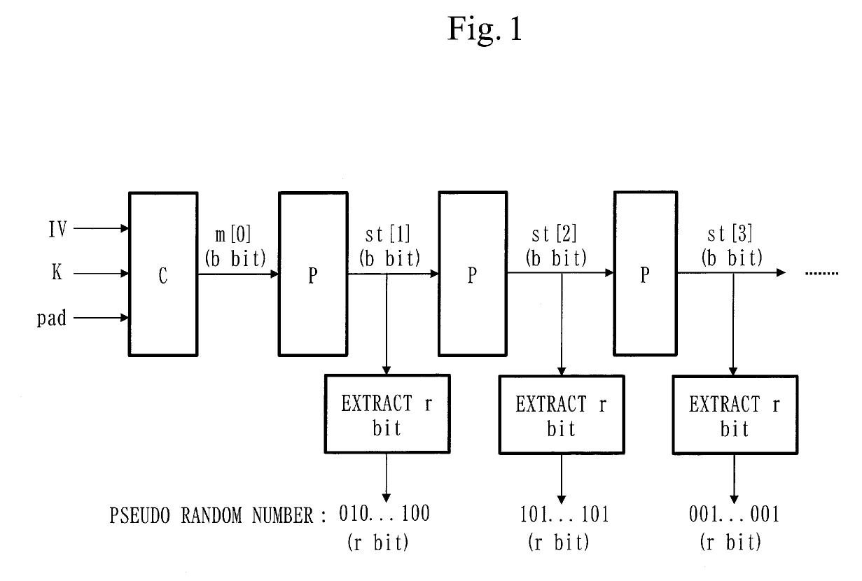

Based on FIG. 1, a configuration of a pseudo-random number generator function using the Sponge construction will be described.

In a pseudo-random number generator function using the Sponge construction, an ideal non-linear function P having an input value of b bits and an output value of b bits is used.

First, by using a function c, a value m[0] made to be b bits is generated by combining a value IV and a secret key K, and further combining a fixed value pad as needed. By taking the value m[0] as input, a value st[1] is calculated by using the non-linear function P. r bits of the value st[1] are substituted for a pseudo random number.

Next, for each integer value i in ascending order, with i=2, . . . , n, values st[i] are calculated by using the non-linear function P taking values st[i−1] as input. r bits of the values st[i] are combined into a pseudo random number. In this manner, a pseudo random numbers is generated.

A value n is determined in accordance with a required bit length of a pseudo random number.

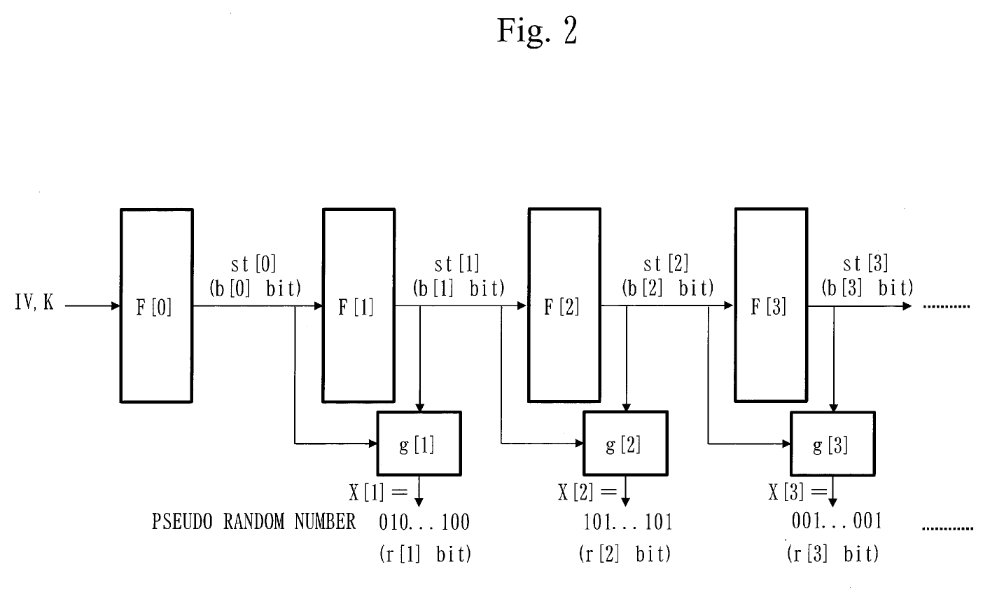

Based on FIG. 2, a configuration of a pseudo-random number generator function according to a first embodiment will be described.

First, a value st[0] of b[0] bits is calculated by using a non-linear function F[0] taking as input an input value IV and a secret key K.

Next, for each integer value i in ascending order, with i=1, . . . , n, a value st[i] of b[i] bits is calculated by using a function F[i] taking a value st[i−1] as input. Then, for at least a part of an integer value i with i=1, . . . , n, a value x[i] of r[i] bits is calculated by using a function g[i] taking as input at least a part of bits of a value st[j] and at least a part of bits of the value st[i], where a value j is an integer value smaller than the integer value i. Here, for each integer value i with i=1, . . . , n, the value x[i] of r[i] bits is calculated by using the function g[i] taking as input at least a part of bits of the value st[i−1] and at least a part of bits of the value st[i].

The values x[i] calculated by using the functions g[i] are combined to be a pseudo-random number.

A value n is a value equal to or greater than 1, which is determined in accordance with a required bit length of a pseudo-random number.

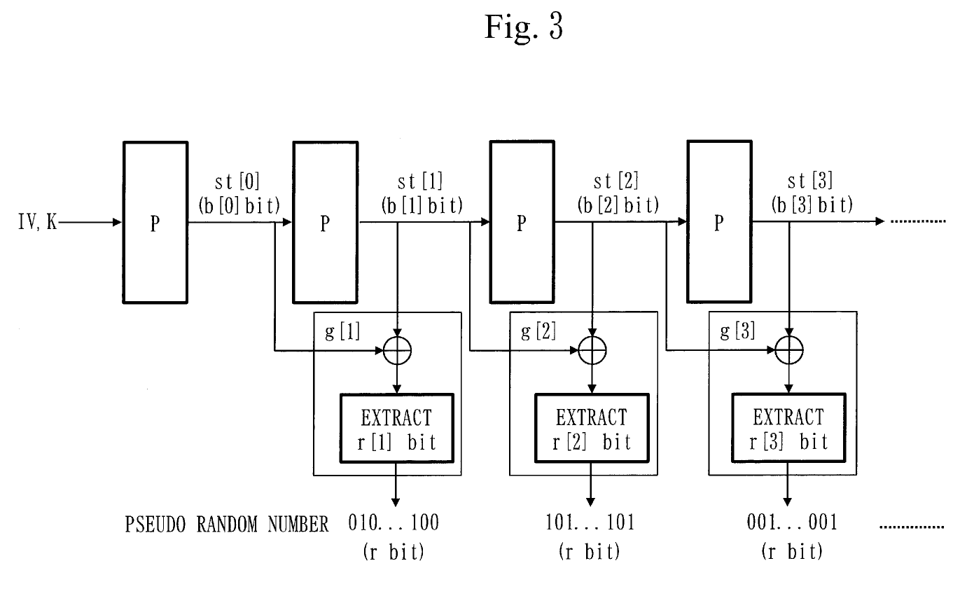

Based on FIG. 3, a configuration of the function g according to the first embodiment will be described.

A function g[i] for each integer value i with i=1, . . . , n calculates an exclusive-OR of at least a part of bits of a value st[i−1] and at least a part of bits of a value st[i]. Then, the function g[i] extracts r[i] bits being at least a part of bits of the exclusive-OR, and outputs r[i] bits as a value x[i].

Here, non-linear functions F[i] for each integer value i with i=1, . . . , n may be a same non-linear function. Further, a non-linear function F[0] may also be the same non-linear function as the non-linear function F[i] for each integer value i with i=1, . . . , n. That is, non-linear functions F[i] for each integer value i with i=0, . . . , n may be the same non-linear function. Of course, the non-linear functions F[i] for each integer value i with i=0, . . . , n may be different functions.

Further, the values st[i] for each integer value i with i=1, . . . , n may have a same bit number. That is, bit numbers b[i] for each integer value i with i=1, . . . , n may be a same b bits.

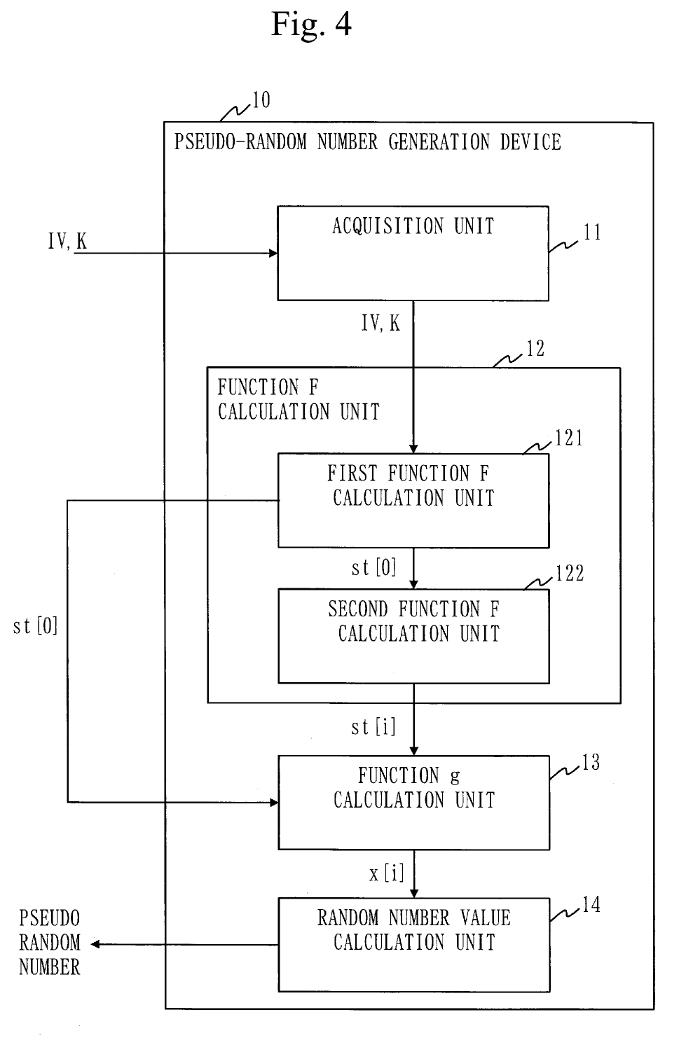

Based on FIG. 4, a configuration of the pseudo-random number generation device 10 according to the first embodiment will be described.

The pseudo-random number generation device 10 calculates the pseudo-random number generator function illustrated in FIG. 2 and generates a pseudo random number. The pseudo-random number generation device 10 is equipped with an acquisition unit 11, a function F calculation unit 12, a function g calculation unit 13 and a random number value calculation unit 14.

The acquisition unit 11 acquires a value IV and a secret key K. The value IV is a value that is different every time a pseudo random number is generated. The secret key K is a key shared beforehand with the other party of a cryptographic communication. Here, it may be also considered a case without using a pseudo-random number in a cryptographic communication. Accordingly, the secret K may not be a key shared beforehand with the other party of the cryptographic communication, but may be an arbitrary value.

It may be possible to let the value IV be input by a user of the pseudo-random number generation device 10 by use of an input device every time a pseudo random number is generated, and the acquisition unit 11 acquire the value IV input. Further, it may also be possible to let the value IV be stored in a storage device included in the pseudo-random number generation device 10, and the acquisition unit 11 acquire the value IV stored. Similarly, it may be also possible to let the secret key K be input by a user of the pseud-random number generation device 10 by use of an input device every time a pseud random number is generated, and the acquisition unit 11 acquire the secret key K input. Further, it may be also possible to let the secret key K be stored in a storage device included in the pseudo-random number generation device 10, and the acquisition unit 11 acquire the secret key K stored.

The function F calculation unit 12 calculates non-linear functions F[i]. The function F calculation unit 12 is equipped with a first function F calculation unit 121 and a second function F calculation unit 122.

The first function F calculation unit 121 calculates a value st[0] by using a function F[0] taking as input the value IV and the secret key K acquired by the acquisition unit 11.

The second function F calculation unit 122 calculates a value st[i] by using the function F[i] taking as input a value st[i−1] for each integer value i in ascending order, with i=1, . . . , n.

The function g calculation unit 13 calculates functions g[i].

The function g calculation unit 13 calculates a value x[i] of r[i] bits by using a functions g[i] taking as input at least a part of bits of a value st[j] and at least a part of bits of a value st[i], where a value j is an integer value smaller than the integer value i. Here, the function g calculation unit 13 calculates a value x[i] of r[i] bits by using a function g[i] taking as input at least a part of bits of a value st[i−1] and at least a part of bits of a value st[i] for each integer value i with i=1, . . . , n.

The random number value calculation unit 14 calculates a pseudo random number from the values x[i] calculated by the function g calculation unit. Here, the random number value calculation unit 14 calculates a pseudo random number by combining the values x[i] for each integer value i with i=1, . . . , n.

The random number value calculation unit 14 outputs a pseudo random number calculated.

### Explanation of Operation

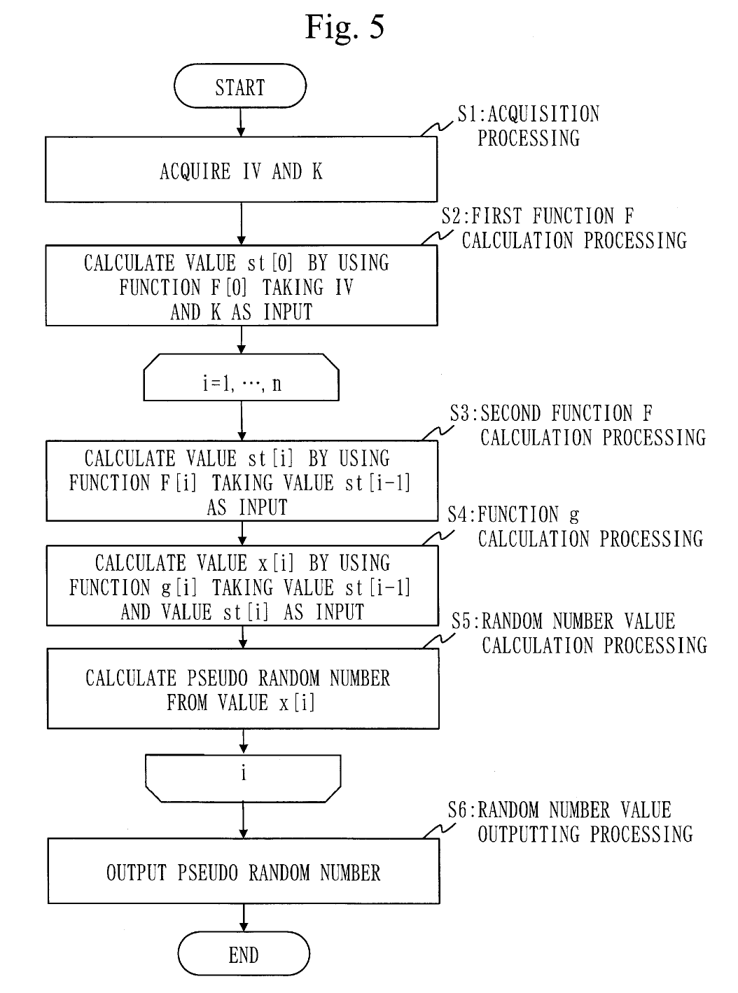

Based on FIG. 5, processing of the pseudo-random number generation device 10 according to the first embodiment will be described.

The processing of the pseudo-random number generation device 10 according to the first embodiment corresponds to a pseudo-random number generation method according to the first embodiment. Further, the processing of the pseudo-random number generation device 10 according to the first embodiment corresponds to processing of a pseudo-random number generation program according to the first embodiment.

In acquisition processing of S1, the acquisition unit 11 acquires a value IV and a secret key K.

In first function F calculation processing of S2, the first function F calculation unit 121 calculates a value st[0] by using a function F[0] taking as input the value IV and the secret key K acquired in S1.

Processing of S3 through S5 is executed for each integer value i in ascending order, with i=1, . . . , n.

In second function F calculation processing of S3, the second function F calculation unit 122 calculates a value st[i] by using a function F[i] taking a value st[i−1] as input.

In function g calculation processing of S4, the function g calculation unit 13 calculates a value x[i] of r[i] bits by using the function g[i] taking as input at least a part of bits of a value st[i−1] and at least a part of bits of the value st[i].

In random number value calculation processing of S5, the random number value calculation unit 14 calculates a pseudo random number by combining the values x[i].

In random number value outputting processing of S6, the random number value calculation unit 14 outputs the pseudo random number calculated.

### Explanation of Effect

As described above, the pseudo-random number generation device 10 according to the first embodiment generates a pseudo random number by using a value st[i] after converting the value st[i] with a value st[i−1] calculated by using the non-linear function F[i−1], without generating a pseudo random number by directly using the value st[i] calculated by using non-linear function F[i]. That is, a pseudo random number is generated by performing a feedforward operation using a value st[i−1] calculated by using the previous non-linear function F[i−1]. Accordingly, it becomes difficult to estimate the value st[i] calculated by using the non-linear function F[i], and it is made possible to make security of indifferentiability not to depend on the value c.

Further, in the pseudo-random number generation device 10 according to the first embodiment, since it is difficult to estimate the value st[i] calculated by using the non-linear function F[i], the differential attack and the linear attack against the non-linear functions F[i] becomes difficult. Therefore, even when the construction of the non-linear function F[i] is simplified, security against the differential attack and the linear attack can be guaranteed. By simplifying the construction of the non-linear function F[i], it is possible to reduce computational complexity of the non-linear function F[i], and to reduce computational complexity of pseudo-random number generation.

Further, it is possible to show that the pseudo-random number generator functions realized by the pseudo random number generation device 10 according to the first embodiment have indifferentiability with a min{b/2, k} bit random number in a case wherein the non-linear functions F[i] for all the integer values i are ideal non-linear functions having an input and output length of b bits. Further, in this case, it is possible to show that security of the non-linear functions F[i] for all the integer values i does not depend on the length b-r.

### Second Embodiment

In a second embodiment, a non-linear function F[i] will be described.

In the second embodiment, parts different from those of the first embodiment will be described.

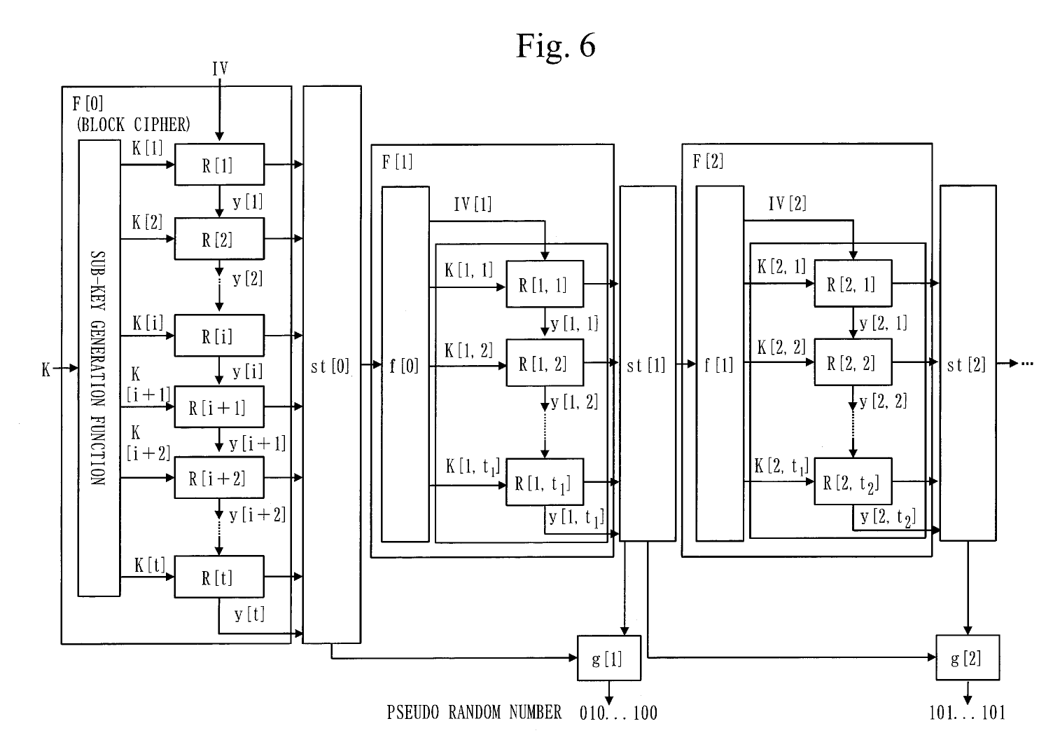

Based on FIG. 6, a configuration of the non-linear function F according to the second embodiment will be described.

A non-linear function F[0] is a function that constructs a block cipher. The non-linear function F[0] includes round functions R[i] for each integer value i with i=1, . . . , t, and a sub-key generation function to generate, from a secret key K, sub-keys K[i] to be input into each round function R[i].

In the non-linear function F[0], the sub-keys K[i] for each integer value i with i=1, . . . , t are first generated by using the sub-key generation function, taking the secret key K as input.

Next, a value y[1] is calculated by using a round function R[1], taking as input a value IV and a sub-key K[1]. Then, values y[i] are generated by using the round functions R[i] taking as input values y[i−1] and the sub-keys K[i] for each integer value i in ascending order, with i=2, . . . , t.

In the non-linear function F[0], a value st[0] is calculated by combining the values y[i] calculated by using round functions R[i] or values inside the round functions R[i], for at least a part of integer values i with i=1, . . . , t.

A non-linear function F[i] for each integer value i with i=2, . . . , n is a function that includes round functions R[i] of at least a part of the round functions R[i] included in the non-linear function F[0], and a function f[i−1] to generate sub-keys K[i] to be input into each round function R[i] from values st[i−1]. That is, the round functions R[i] included in the non-linear function F[i] for each integer value i with i=2, . . . , n are round functions R[i] that are at least a part of and selected from the round functions R[i] included in the non-linear function F[0]. Here, the round functions R[i] included in the non-linear function F[i] for each integer value i with i=2, . . . , n are denoted by round functions R[i, j] for each integer value j with j=1, . . . , tᵢ.

In the non-linear function F[i], a value IV[i] and a sub-key K[i, j] for each integer value j with j=1, . . . , tᵢ are first generated by using the function f[i−1] taking a value st[i−1] as input. Here, in the function f[i−1], a part of bits selected from the bits of the value st[i−1] is taken as an input value into a round function R[i, 1] to be calculated first, and parts of bits selected from the bits of st[i−1] are taken as sub-keys K[i, j] to be used in each round function R[i, j].

Next, a value y[i, 1] is calculated by using a round function R[i, 1] taking as input the value IV[i] and the sub-key K[i, 1]. Then, values y[i, j] are generated by using the round functions R[i, j] taking, as input, values y[i, j−1] and the sub-keys K[i, j] for each integer value j in ascending order, with j=2, . . . , tᵢ.

In the non-linear function F[i], a value st[j] is calculated by combining values y[i, j] calculated by using the round functions R[i, j] for at least a part of the integer values j with j=1, . . . , tᵢ.

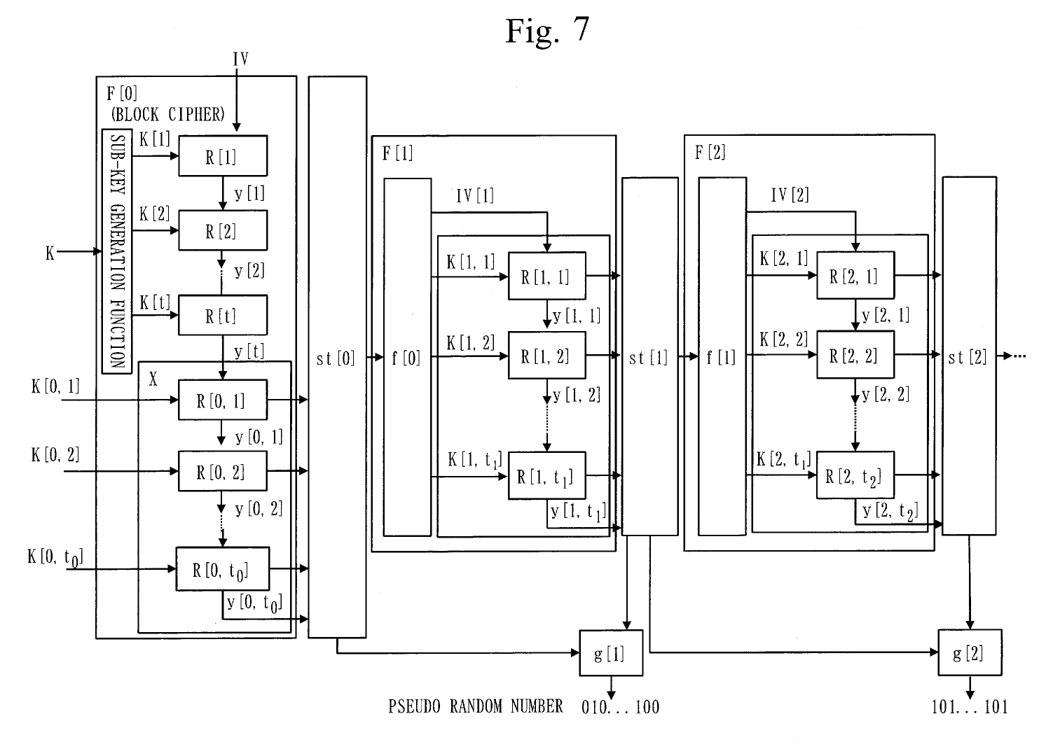

Based on FIG. 7, another configuration of the non-linear function F according to the second embodiment will be described.

As for the non-linear function F illustrated in FIG. 7, parts different from those in the non-linear function F in FIG. 6 will be described.

A non-linear function F[0] includes functions that construct the same block cipher as in the non-linear function F[0] illustrated in FIG. 6. Further, the non-linear function F[0] includes a function X to calculate a round function R[i] being at least a part of the round functions R[i] included in the block cipher in sequence. The round function R[i] included in the function X is a round function R[i] that is at least a part of and selected from the round functions R[i] included in the block cipher. Here, the round function R[i] included in the function X is denoted by a round function [0, j] for each integer value j with j=1, . . . , t₀.

In the non-linear function F[0], a sub-key K[i] is generated for each integer value i with i=1, . . . , t, by using a sub-key generation function taking the secret key K as input.

Next, a value y[1] is calculated by using a round function R[1] taking as input a value IV and a sub-key K[1]. Then, a value y[i] is generated by using the round function R[i] taking, as input, a value y[i−1] and a sub-key K[i] for each integer value i in ascending order, with i=2, . . . , t.

Next, a value y[0, 1] is calculated by using a round function R[0, 1] taking, as input, a value y[t] and a sub-key K[0, 1]. Then, values y[0, j] are calculated by using round functions R[0, j] taking, as input, values y[0, j−1] and sub-keys K[0, j] for each integer value j in ascending order, with j=2, . . . , t₀. Here, the sub-keys K[0, j] for each integer value j with j=1, . . . , t₀ are the sub-keys K[i] input into the round functions R[i] included in the block cipher, which correspond to the round functions R[0, j]. For example, if the round function R[0, 1] is a round function R[3], the sub-key K[0, 1] is a sub-key K[3].

In the non-linear function F[0], a value st[0] is calculated by combining at least a part of the values y[i] calculated by using the round functions R[i] for each integer value i with i=1, . . . , t, and the values y[0, j] calculated by using the round functions R[0, j] for each integer value j with j=1, . . . , t₀.

Non-linear functions F[i] for each integer value i with i=2, . . . , n is the same as the non-linear functions F[i] illustrated in FIG. 6.

As described above, in the pseudo-random number generation device 10 according to the second embodiment, functions that construct a block cipher or components of functions that construct a block cipher are assumed to be non-linear functions F. Especially, in the pseudo-random number generation device 10 according to the second embodiment, sub-keys for round functions R are not fixed, and generated from input into the non-linear functions F. Further, in the pseudo-random number generation device 10 according to the second embodiment, output values obtained by combining the values calculated by using at least a part of the round functions R are taken as output values of the non-linear functions F, without making the output values of the functions that construct the block cipher directly be output values of the non-linear functions F.

In this manner, it is possible to increase the input and output length of the non-linear functions F. As described in the first embodiment, it is possible to show that a pseudo-random number generator function has indifferentiability with a min {b/2, k} bit random number in a case wherein the non-linear functions F[i] for all the integer values i are ideal non-linear functions having an input and output length of b bits. Therefore, when the input and output length of the non-linear functions F can be increased, it is possible to increase the length of a random number with which it is possible to show that there exists indifferentiability.

Further, the pseudo-random number generation device 10 according to the second embodiment performs a feedforward operation as in the pseudo-random number generation device 10 according to the first embodiment, and generates a pseudo random number. Therefore, it is difficult to estimate values calculated by using the non-linear functions F. Thus, it is possible to ensure security even when the number of the round functions R included in the non-linear functions F is reduced. By reducing the number of the round functions R included in the non-linear functions F, it is possible to reduce computational complexity of pseudo random number generation.

Here, as a block cipher, the AES (Advanced Encryption Standard) described in Non-Patent Literature 3 can be used. Further, as a block cipher, Camellia (registered trademark) described in Non-Patent Literature 4 can also be used.

In a case of using the AES as a block cipher, all the round functions are AES round functions.

In a case of using AES with a 128 bit key, with the structure of the non-linear functions F in FIG. 6, t is 10, and tᵢ is equal to or smaller than 10.

In a case of using AES with a 128 bit key, with the structure of the non-linear functions F in FIG. 7, t is 10, and tᵢ is equal to or smaller than 10.

In a case of using AES with a 192 bit key, with the structure of the non-linear functions F in FIG. 6, t is 12, and tᵢ is equal to or smaller than 12.

In a case of using AES with a 192 bit key, with the structure of the non-linear functions F in FIG. 7, t is 12, and tᵢ is equal to or smaller than 12.

In a case of using AES with a 256 bit key, with the structure of the non-linear functions F in FIG. 6, t is 14, and tᵢ is equal to or smaller than 14.

In a case of using AES with a 256 bit key, with the structure of the non-linear functions F in FIG. 7, t is 14, and tᵢ is equal to or smaller than 14.

In a case of using Camellia (registered trademark) as a block cipher, all the round functions are Camellia (registered trademark) round functions.

In a case of using Camellia (registered trademark) with a 128 bit key, with the construction of the non-linear functions F in FIG. 6, t is 18, and tᵢ is equal to or smaller than 18. Further, as f[i], sub-key generation functions in Camellia (registered trademark) with a 128 bit key may be used.

In a case of using Camellia (registered trademark) with a 128 bit key, with the construction of the non-linear functions F in FIG. 7, t is 18, and tᵢ is equal to or smaller than 18. Further, as f[i], sub-key generation functions in Camellia (registered trademark) with a 128 bit key may be used.

In a case of using Camellia (registered trademark) with a 192 bit key, with the construction of the non-linear functions F in FIG. 6, t is 24, and tᵢ is equal to or smaller than 24. Further, as f[i], sub-key generation functions in Camellia (registered trademark) with a 192 bit key may be used.

In a case of using Camellia (registered trademark) with a 192 bit key, with the construction of the non-linear functions F in FIG. 7, t is 24, and tᵢ is equal to or smaller than 24. Further, as f[i], sub-key generation functions in Camellia (registered trademark) with a 192 bit key may be used.

In a case of using Camellia (registered trademark) with a 256 bit key, with the construction of the non-linear functions F in FIG. 6, t is 24, and tᵢ is equal to or smaller than 24. Further, as f[i], sub-key generation functions in Camellia (registered trademark) with a 256 bit key may be used.

In a case of using Camellia (registered trademark) with a 256 bit key, with the construction of the non-linear functions F in FIG. 7, t is 24, and tᵢ is equal to or smaller than 24. Further, as f[i], sub-key generation functions in Camellia (registered trademark) with a 256 bit key may be used.

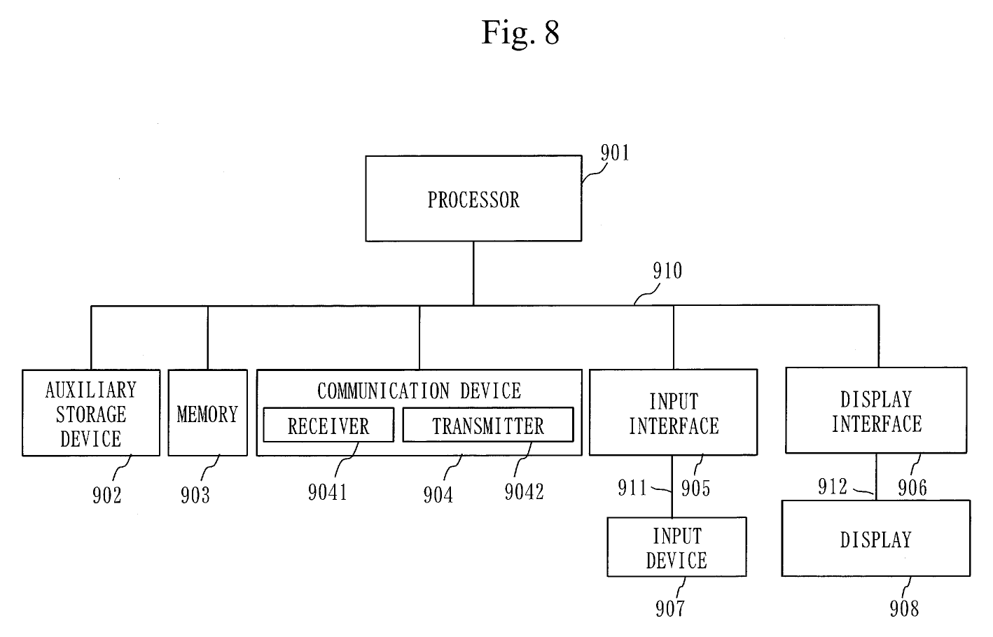

FIG. 8 is a diagram describing an example of a hardware configuration of the pseudo-random number generation device 10 according to the first and second embodiments.

The pseudo-random number generation device 10 is a computer.

The pseudo-random number generation device 10 is equipped with hardware such as a processor 901, an auxiliary storage device 902, a memory 903, a communication device 904, an input interface 905 and a display interface 906, etc.

The processor 901 is connected to other hardware via a signal line 910 to control pieces of the other hardware.

The input interface 905 is connected to an input device 907 via a cable 911.

The display interface 906 is connected to a display 908 via a cable 912.

The processor 901 is an IC (Integrated Circuit) that performs processing. The processor 901 is, for example, a CPU (Central Processing Unit), a DSP (Digital Signal Processor), or a GPU (Graphics Processing Unit).

The auxiliary storage device 902 is, for example, a ROM (Read Only Memory), a flash memory, or an HDD (Hard Disk Drive).

The memory 903 is, for example, a RAM (Random Access Memory).

The communication device 904 includes a receiver 9041 to receive data and a transmitter 9042 to transmit data. The communication device 904 is, for example, a communication chip or an NIC (Network Interface Card).

The input interface 905 is a port whereto the cable 911 of the input device 907 is connected. The input interface 905 is, for example, a USB (Universal Serial Bus) terminal.

The display interface 906 is a port whereto the cable 912 of the display 908 is connected. The display interface 906 is, for example, a USB terminal or an HDMI (registered trademark) (High Definition Multimedia Interface) terminal.

The input device 907 is, for example, a mouse, a keyboard, or a touch panel.

The display 908 is, for example, an LCD (Liquid Crystal Display).

In the auxiliary storage device 902, programs to realize the functions of the acquisition unit 11, the function F calculation unit 12, the first function F calculation unit 121, the second function F calculation unit 122, the function g calculation unit 13, the random number value calculation unit 14 (hereinafter, the acquisition unit 11, the function F calculation unit 12, the first function F calculation unit 121, the second function F calculation unit 122, the function g calculation unit 13, the random number value calculation unit 14 are collectively referred to as “units”) as described above are stored.

The programs are loaded into the memory 903, read into the processor 901, and executed by the processor 901.

Further, an OS (operating system) is stored in the auxiliary storage device 902.

Then, at least a part of the OS is loaded into the memory 903, and the processor 901 executes the programs to realize the functions of the “units” while executing the OS.

In FIG. 8, one processor 901 is illustrated; however, the pseudo-random number generation device 10 may be equipped with a plurality of processors 901. Then, the plurality of processors 901 may execute the programs to realize the functions of the “units” cooperatively.

Additionally, information, data, signal values or variable values indicating the results of the processing by the “units” are stored in the memory 903, the auxiliary storage device 902, or a register or a cache memory in the processor 901 as files.

The “units” may be provided by “circuitry.” Further, the “units” may be replaced with “circuits,” “steps,” “procedures” or “processing.” The “circuits” and “circuitry” are concepts including not only the processor 901 but also processing circuits of other types, such as a logic IC, a GA (Gate Array), an ASIC (Application Specific Integrated Circuit) and an FPGA (Field-Programmable Gate Array).

### REFERENCE SIGNS LIST

10: pseudo-random number generation device; 11: acquisition unit; 12: function F calculation unit; 121: first function F calculation unit; 122: second function F calculation unit; 13: function g calculation unit; 14: random number value calculation unit

1. A pseudo-random number generation device comprising:
processing circuitry to:
calculate a value st[0] by using a function F[0];
calculate a value st[i] by using a function F[i] taking a value st[i−1] as input, for each integer value i with i=1, . . . , n in ascending order, where a value n is an integer value equal to or larger than 1;
calculate a value x[i] by using a function g[i] to perform an operation using both of at least a part of bits of a value st[j] and at least a part of bits of the value s[i], taking as input at least a part of bits of the value st[j] and at least a part of bits of the value st[i], for at least a part of an integer value i with i=1, . . . , n, where a value j is an integer value smaller than the integer value i; and
calculate a pseudo random number from the value x[i] calculated.

2. The pseudo-random number generation device as defined in claim 1,
wherein the processing circuitry calculates the value x[i] by using the function g[i] taking as input at least a part of bits of the value st[i−1] and at least a part of bits of the value st[i], for each integer value i with i=1, . . . , n.

3. The pseudo-random number generation device as defined in claim 1,
wherein the function F[i] for each integer value i with i=1, . . . , n is a same non-linear function.

4. The pseudo-random number generation device as defined in claim 1,
wherein the function F[i] for each integer value i with i=0, . . . , n is a same non-linear function.

5. The pseudo-random number generation device as defined in claim 1,
wherein the function F[0] is a function to calculate a round function R[i] for each integer value i with i=1, . . . , t sequentially, the round function R[i] constructing a block cipher, where a value t is an integer number equal to or larger than 1, and
wherein the function F[i] for each integer value i with i=1, . . . , n is a function to sequentially calculate a round function R[i] being at least a part of the round function R[i] calculated in the function F[0].

6. The pseudo-random number generation device as defined in claim 1,
wherein the function F[0] is a function to calculate a round function R[i] for each integer value i with i=1, . . . , t sequentially, the round function R[i] constructing a block cipher, where a value t is an integer number equal to or larger than 1, and further, to calculate a round function R[i] being at least a part of the round function R[i] sequentially, and
wherein the function F[i] for each integer value i with i=1, . . . , n is a function to sequentially calculate a round function R[i] being at least a part of the round function R[i] calculated in the function F[0].

7. The pseudo-random number generation device as defined in claim 5,
wherein the processing circuitry calculates the value st[0] by combining values that are calculated by using the round function R[i] being at least the part of the round function R[i] calculated in the function F[i], and
wherein the processing circuitry calculates the value st[i] by combining values calculated by using the round function R[i] being at least the part of the round function R[i] calculated in the function F[i].

8. The pseudo-random number generation device as defined in claim 5,
wherein the processing circuitry takes a part of bits selected from bits of the value st[i−1] as an input value into a round function R[i] that is calculated first, and a part of bits selected from the bits of the value st[i−1] as a key used for each round function R[i].

9. The pseudo-random number generation device as defined in claim 5,
wherein the block cipher is AES (Advanced Encryption Standard), and the round function R[i] for each integer value i with i=1, . . . , t is a round function in AES.

10. The pseudo-random number generation device as defined in claim 5,
wherein the block cipher is Camellia (registered trademark), and the round function R[i] for each integer value i with i=1, . . . , t is a round function in Camellia (registered trademark).

11. The pseudo-random number generation device as defined in claim 2,
wherein the function g[i] for each integer value i with i=1, . . . , n is a function to calculate an exclusive OR of at least a part of bits of the value st[i−1] and at least a part of bits of the value st[i], and output at least a part of bits as the value x[i].

12. The pseudo-random number generation device as defined in claim 11,
wherein the value st[i] for each integer value i with i=1, . . . , n has a same number of bits.

13. A non-transitory computer readable medium storing a pseudo-random number generation program that causes a computer to execute:
first function F calculation processing to calculate a value st[0] by using a function F[0];
second function F calculation processing to calculate a value st[i] by using a function F[i] taking a value st[i−1] as input, for each integer value i with i=1, . . . , n in ascending order, where a value n is an integer value equal to or larger than 1;
function g calculation processing to calculate a value x[i] by using a function g[i] to perform an operation using both of at least a part of bits of a value st[j] and at least a part of bits of the value st[i], taking as input at least a part of bits of the value st[j] and at least a part of bits of the value st[i], for at least a part of an integer value i with i=1, . . . , n, where a value j is an integer value smaller than the integer value i; and
random number value calculation processing to calculate a pseudo random number from the value x[i] calculated by the function g calculation processing.
